(19) United States
(12) Patent Application Publication
(10) Pub. No.: US 2011/0053638 A1
(43) Pub. Date: Mar. 3, 2011

(54) MOBILE TERMINAL DEVICE AND COMMUNICATION CONTROL METHOD

(75) Inventors: Takafumi NAKAMURA, Tokyo (JP); Yoshiaki Hata, Tokyo (JP); Go Masui, Tokyo (JP)

(73) Assignee: KABUSHIKI KAISHA TOSHIBA, TOKYO (JP)

(21) Appl. No.: 12/756,260

(22) Filed: Apr. 8, 2010

(30) Foreign Application Priority Data
Aug. 25, 2009 (JP) P2009-194821

(51) Int. Cl. H04M 1/00

(52) U.S. Cl. 455/552.1

(57) ABSTRACT

A mobile terminal device includes a first communication module which performs first wireless communication according to a first communication system, a second communication module which performs second wireless communication according to a second communication system, a main controller which controls the first wireless communication module and the second wireless communication module, and the controller determines whether the first wireless communication should be continued in accordance with a condition of communication processing performed by the first wireless communication module.

### CROSS-REFERENCE TO RELATED APPLICATIONS

The present disclosure relates to the subject matters contained in Japanese Patent Application No. 2009-194821 filed on Aug. 25, 2009, which are incorporated herein by reference in its entirety.

### BACKGROUND

1. Field

The present disclosure relates to a mobile terminal device and a communication control method that perform wireless communication according to a plurality of wireless communication systems.

2. Description of Related Art

Recently, the number of mobile terminal devices such as cellular phones and notebook personal computers that can perform wireless communication according to a plurality of wireless communication systems has increased. JP-A-2003-87269 discloses a related-art mobile information device that performs wireless communication according to a plurality of communication systems.

The mobile information device disclosed in JP-A-2003-87269 includes: a first wireless module that performs wireless communication according to a first communication system; a second wireless module that performs wireless communication according to a second communication system; selecting module for allowing one of the first wireless module and the second wireless module to be selected; and a controller that, in a case where one of the first wireless module and the second wireless module is selected by the selecting module, sets wireless communication through the other of the first wireless module and the second wireless module to a non-usable state and then sets wireless communication through the selected one of the first wireless module and the second wireless module to a usable state.

According to the related-art mobile information device, by selectively using one of the first wireless module and the second wireless module, a problem of interference between wireless communication signals thereof can be prevented in advance even in a case where frequency bands used in the first communication system and the second communication system are close to each other.

However, according to the related-art mobile information device disclosed in JP-A-2003-87269, a content of the wireless communication that is currently performed is not considered when switching among the plurality of wireless communication modules is performed. When a request for starting wireless communication according to one communication system is generated, the related-art mobile information device forcibly stops the wireless communication that is currently performed according to the other communication system. Thus, in a case where a request for starting wireless communication according to one communication system is generated, a process is forcibly stopped even when the wireless communication process requiring continuity is performed. Accordingly, in a case where a request for starting wireless communication according to one communication system is generated, data in the middle of transmission or reception process may disappear, the transmission or reception of the data that has been stopped needs to be performed from the beginning again, or the like. Therefore, a user's convenience is damaged.

### SUMMARY

Exemplary embodiments of this invention provide a mobile terminal device which includes a first communication module which performs first wireless communication according to a first communication system, a second communication module which performs second wireless communication according to a second communication system, and a main controller which controls the first communication module and the second communication module. The main controller controls the first communication module to continue the first wireless communication by rejecting a request for starting the second wireless communication while given communication processing is performed by the first communication module. The main controller controls the first communication module to terminate the first wireless communication and controls the second communication module to perform the second wireless communication in response to the request, when the given communication processing is not performed.

### BRIEF DESCRIPTION OF THE DRAWINGS

An exemplary embodiment of the present invention may be described in detail with reference to the accompanying drawings, in which:

FIG. 1 is an exemplary diagram showing an entire configuration of a mobile terminal device according to an exemplary embodiment of the present invention;

FIG. 2 is an exemplary block diagram showing an internal configuration of the mobile terminal device;

FIG. 3 is an exemplary block diagram showing a configuration of a function implementing unit that is configured by a CPU of a main controller;

FIG. 4 is an exemplary diagram showing a use state of a wireless communication antenna according to a related art in a case where there is a request for starting WLAN communication in the middle of a BT communication;

FIG. 5 is an exemplary diagram showing an example of a use state of a wireless communication antenna of a mobile terminal device according to the exemplary embodiment in a case where there is a request for starting WLAN communication in the middle of the BT communication;

FIG. 6 is an exemplary diagram showing another example of the use state of the wireless communication antenna of the mobile terminal device according to the exemplary embodiment in a case where there is a request for starting WLAN communication in the middle of the BT communication; and

FIG. 7 is an exemplary flowchart showing a procedure for switching among a plurality of communication systems according to a content of a current wireless communication by using the main controller of the mobile terminal device shown in FIG. 1.

### DETAILED DESCRIPTION

A mobile terminal device and a communication control method according to exemplary embodiments of the present invention will be described with reference to the accompanying drawings.

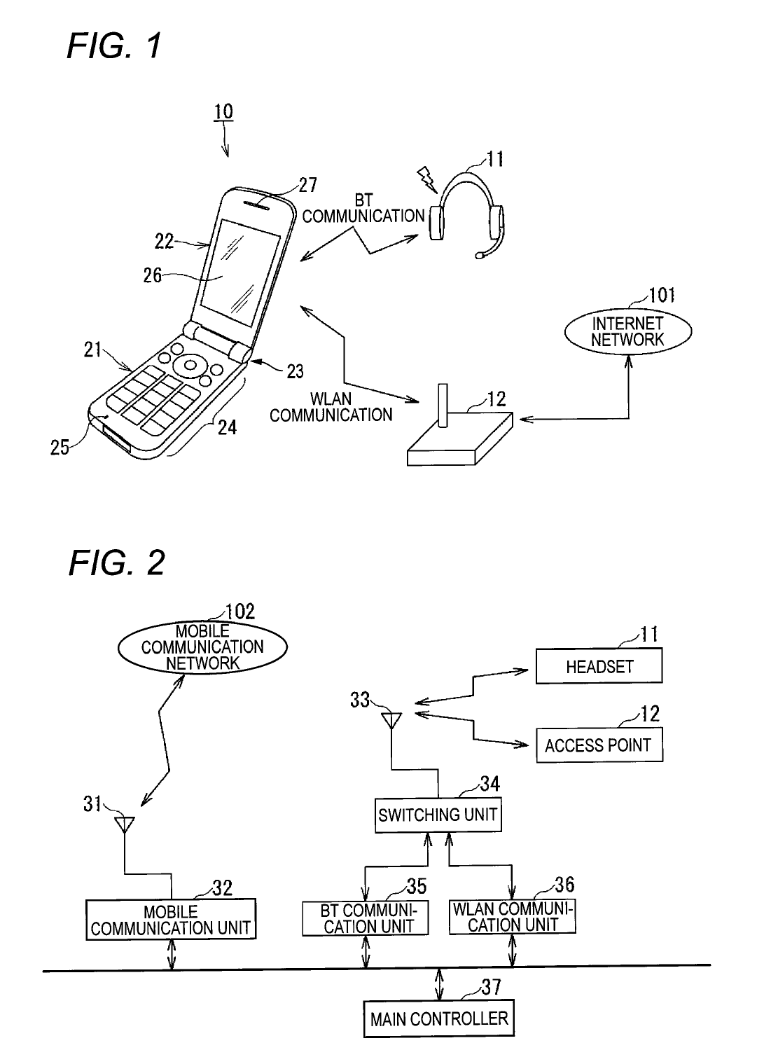

FIG. 1 is an exemplary diagram showing an entire configuration of a mobile terminal device according to an exemplary embodiment. The present disclosure can be applied to various mobile terminal devices that perform wireless communication according to a plurality of wireless communication systems. The exemplary embodiment shows a case where a cellular phone 10 that performs wireless communication according to a plurality of wireless communication systems is used as the mobile terminal device according to the present invention.

The cellular phone 10 can perform wireless communication according to a communication system compliant with local area wireless communication standards such as BLUETOOTH® (hereinafter referred to as BT) standard in addition to wireless communication through a wireless LAN (Wireless Local Area Network) (hereinafter referred to as a WLAN) using each system of an IEEE802.11 series (IEEE802.11a/b/g/j/n, etc.).

In the description below, an example of a case where the cellular phone 10 can at least perform wireless communication according to a communication system of a 2.4 GHz band (ISM band) compliant with the BT standards and wireless communication through a WLAN according to a communication system of IEEE802.11b/g/n of a 2.4 GHz band (ISM band) will be described.

The cellular phone 10, as shown in FIG. 1, transmits or receives data to or from a headset 11 through wireless communication (hereafter referred to as BT communication) according to a communication system compliant with the BT standards. In addition, the cellular phone 10 transmits or receives data to or from an access point 12 (hereinafter referred to as an AP) through wireless communication (hereinafter referred to as WLAN communication) according to a communication system of IEEE802.11b/g/n as the second communication system. The AP 12 is connected to the Internet network 101 in a wired or wireless manner.

The cellular phone 10 has a first housing 21, a second housing 22, and a connection portion 23, such as a hinge unit, that connects the second housing 22 to the first housing 21 so as to be freely opened or closed.

As shown in FIG. 1, the second housing 22 is connected to the first housing 21 through the connection portion 23 so as to be freely opened or closed with an opening/closing axis used as the center. As the second housing 22 rotates about the opening/closing axis, the cellular phone 10 can be positioned in an opened state, as shown in FIG. 1, or a closed state.

The first housing 21 is a thin box-shape casing. On a surface of a top face of the casing of the first housing 21, an input device 24 and a microphone 25 are disposed. The second housing 22 is a thin box-shape casing. On a surface of a top face of the casing of the second housing 22, a display portion 26 and a receiver 27 are disposed.

The input device 24 is a general input device such as a numeric keypad or a touchscreen and outputs a signal corresponding to a user's input operation. In addition, a part of the input device 24 may be a rotary input device. The rotary input portion is an input device that outputs a signal corresponding to a rotary operation. The rotary input device may be a magnetic-type rotary encoder or the like. The rotary input device is operated by a user, for example, through a rotary ring. Each time the rotary ring is rotated by a given amount of rotation, the rotary input device outputs a rotary signal corresponding to a forward or backward direction of rotation.

The microphone 25 converts a user's voice into an analog voice signal, thereafter the analog voice signal is converted into a digital voice signal by an A/D converter (not shown).

The display device 26 is a general display device such as a liquid crystal display or an Organic Light Emitting Device (OLED) display. A background image, such as a wall paper, is displayed on the display device 26, and various icons such as images schematically representing a remaining amount of a battery or an intensity of electric waves are also displayed on the display device 16. The various icons are displayed on the background image. Also, an image or a video indicating reception of an incoming all or an email, or other image is displayed on the display device 26.

The receiver 27 outputs a sound corresponding to various types of information such as received voice.

FIG. 2 is an exemplary block diagram showing an internal configuration of the cellular phone 10.

As shown in FIG. 2, the cellular phone 10, additionally, has a mobile communication antenna 31, a mobile communication unit 32, a wireless communication antenna 33, a switching unit 34, a BT communication unit 35, a WLAN communication unit 36, and a main controller 37.

The mobile communication unit 32 transmits or receives sound and data through the mobile communication antenna 31 and a wireless communication network 102 under the control of the main controller 37. The mobile communication unit 32 and the BT communication unit 35 can cooperate with each other. In such a case, a user can call through the mobile communication network 102 by using a headphone and a microphone of the headset 11.

The wireless communication antenna 33 is selectively connected to one of the BT communication unit 35 and the WLAN communication unit 36 through the switching unit 34. The wireless communication antenna 33 has a configuration that is appropriate for wireless electric waves of the 2.4 GHz band.

The switching unit 34 has one end connected to the wireless communication antenna 33 and the other end connected to one of the BT communication unit 35 and the WLAN communication unit 36. A connection destination of the other end of the switching unit 34 is controlled by the WLAN communication unit 36 and the main controller 37.

The BT communication unit 35 transmits or receives audio data to or from at least the headset 11 through the BT communication according to the communication system (2.4 GHz band) compliant with the BT standard under the control of the main controller 37. For example, the BT communication unit 35 can deliver music data stored in the cellular phone 10 to the headset 11 through the BT communication. The BT communication unit 35 according to the exemplary embodiment supports an Enhanced Data Rate (EDR). The BT communication unit 35, at a time of pairing with a target device such as the headset 11 that performs the BT communication, acquires data including information of whether communication using the EDR can be performed and supplies the data to the main controller 37. The main controller 37 stores the information in a work area of a RAM.

The WLAN communication unit 36 transmits or receives data to or from at least the AP 12 through the WLAN communication according to the communication system (2.4 GHz band) of IEEE802.11b/g/n under the control of the main controller 37.

The BT communication unit 35 and the WLAN communication unit 36 may be configured by a one-chip microcomputer that has a CPU and a storage medium such as a RAM (Random Access Memory). In addition, the BT communication unit 35 and the WLAN communication unit 36 may be configured to be able to transmit or receive information such as a communication request signal or a communication state to or from each other. In such a case, the BT communication unit 35 and the WLAN communication unit 36 can save data into a buffer memory without instructions from the main controller 37 when switchover occurs between communication systems.

The main controller 37 is configured by a CPU and a storage medium such as a RAM and a ROM (Read Only Memory). The main controller 37 controls an operation of the cellular phone 10 according to a program that is stored on the ROM.

The CPU of the main controller 37 loads a communication control program stored in the ROM and data needed for executing the control program into the RAM and performs a process of switching among a plurality of communication systems based on the status of the current wireless communication.

The RAM of the main controller 37 provides a work area in which a program executed by the CPU of the main controller 37 and data are temporarily stored.

The storage medium of the main controller 37 stores a start-up program, a communication control program, a BT communication program, and a WLAN communication program of the cellular phone 10 and a variety of data needed for executing these programs therein. Generally, the start-up program, a communication control program, the BT communication program, and the WLAN communication program are stored in the ROM, and the data needed for executing the programs described above is stored in the RAM.

The storage medium may be a magnetic recording medium, an optical recording medium, a semiconductor memory, or a User Identity Module (UIM) card installed to a card slot, accessible from the CPU. A part or the whole of the program and data stored inside the storage medium may be configured to be downloaded through a network.

The network indicates a general information communication network that utilizes electronic communication technology. The network includes a communication network built by the BT communication, a telephone communication network including the mobile communication network 102, an optical fiber communication network, a cable communication network, and a satellite communication network, other than the wired/wireless LAN and the Internet network 101.

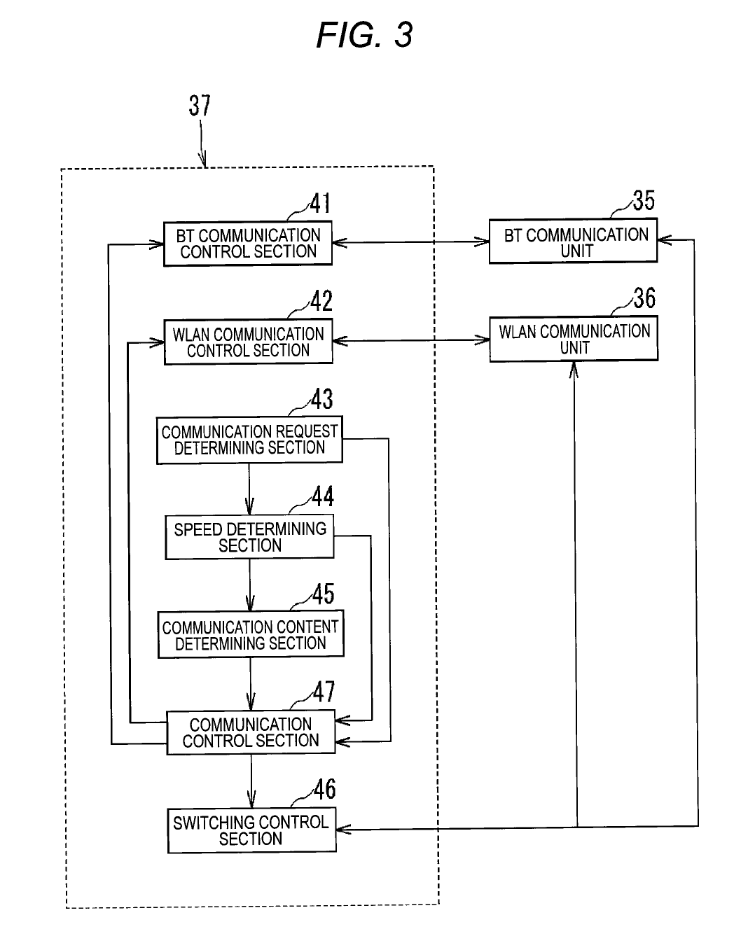

FIG. 3 is an exemplary block diagram showing a configuration example of a function implementing unit that is configured by the CPU of the main controller 37. Alternatively, the function implementing unit may be configured by a hardware logic such as a circuit without using the CPU.

The CPU of the main controller 37 works as a BT communication control section 41 and a WLAN communication control section 42 according to the BT communication program and the WLAN communication program, respectively. In addition, the CPU of the main controller 37 works as a communication request determining section 43, a speed determining section 44, a communication content determining section 45, a switching control section 46, and a communication control section 47 according to the communication control program. These sections 41 to 47 use required work areas of the RAM as temporary storage places.

The BT communication program and the WLAN communication program are middleware that connects the main controller 37 and the BT communication unit 35 together and connects the main controller 37 and the WLAN communication unit 36 together, respectively.

The BT communication control section 41 controls the BT communication unit 35 so as to implement the BT communication under the control of the communication control section 47. For example, the BT communication control section 41, at the time of pairing with a target device such as the headset 11 that performs the BT communication, acquires data including information of whether communication using the EDR can be performed from the BT communication unit 35 and stores the information in a required work area of RAM of the main controller 37.

In addition, when starting the BT communication, the BT communication control section 41 stores profile information of the BT communication in a work area of the RAM. Then, when completing the BT communication, the BT communication control section 41 deletes the profile information stored in the work area of the RAM of the main controller 37. As a result, when BT communication is performed, the main controller 37 can check the profile information of the current BT communication by searching for the work area of the RAM. For example, in a case where music data is delivered to the headset 11 by the BT communication unit 35 through an Advanced Audio Distribution Profile (A2DP), information indicating that currently the BT communication is performed through the A2DP is maintained in the work area of the RAM of the main controller 37.

The WLAN communication control section 42 controls the WLAN communication unit 36 so as to implement the WLAN communication under the control of the communication control section 47. For example, when failing to receive a beacon from the access point, the WLAN communication control section 42 outputs a request signal for starting an automatic search for the access point through WLAN communication to the communication control section 47.

When BT communication is performed by the BT communication unit 35, the communication request determining section 43 determines whether there has been a request for starting WLAN communication from the WLAN communication control section 42. As the request for starting WLAN communication, for example, there is a request for starting an automatic search process for the AP 12 through WLAN communication or the like for a case where the automatic search for the AP 12 through WLAN communication is needed as the user moves with the cellular phone 10 held. In the description below, an example in which the “request for starting WLAN communication” is a “request for starting an automatic search for the AP 12 through the WLAN communication” will be represented.

The speed determining section 44 determines whether the BT communication, which is performed by the BT communication unit 35, is performed at a speed equal to or higher than a given speed. In the exemplary embodiment, an example of a case where the speed determining section 44 determines whether the BT communication is performed at a speed equal to or higher than the given speed based on whether a target device, for which the BT communication unit 35 performs the BT communication, is in correspondence with the EDR (Enhanced Data Rate) will be described.

The speed determining section 44 can determine whether BT communication is performed at a speed equal to or higher than the given speed based on the information, which is stored in the required work area of the RAM of the main controller 37, indicating whether communication is performed according to the EDR. In addition, in a case where communication speed measuring means for measuring the communication speed of BT communication in real time is provided in the cellular phone 10, the speed determining section 44 may be configured to make a determination based on an output of the measuring means.

The communication content determining section 45 determines whether the BT communication process performed by the BT communication unit 35 is a predetermined process. In the exemplary embodiment, an example of a case where the communication content determining section 45 determines the BT communication process performed by the BT communication unit 35 to be the predetermined process in a case where the BT communication is performed according to an Advance Audio Distribution Profile (A2DP), a HeadSet Profile (HSP), a Hands-Free Profile (HFP), or any other audio/video data transmission profile will be described. It is preferable that a profile such as an audio/video data transmission profile that handles data causing a problem in a case where transmission of the data is not sequentially performed includes a profile that is performed by the predetermined process.

Here, the information on the profile that becomes a reference for the determination of the communication content determining section 45 may be stored in the ROM of the main controller 37 in advance or may be configured to be downloaded through an electronic network and stored in the storage medium.

The switching control section 46 connects the other end of the switching unit 34 to one of the BT communication unit 35 and the WLAN communication unit 36 by controlling the switching unit 34 through the BT communication unit 35 or the WLAN communication unit 36 under the control of the communication control section 47. A function of the switching control section 46 may be implemented in the BT communication unit 35 or the WLAN communication unit 36. For example, in a case where the function of the switching control section 46 is implemented in the WLAN communication unit 36, the switching unit 34 may be controlled by the WLAN communication unit 36. In such a case, the function of the switching control section 46 may not be implemented in the main controller 37.

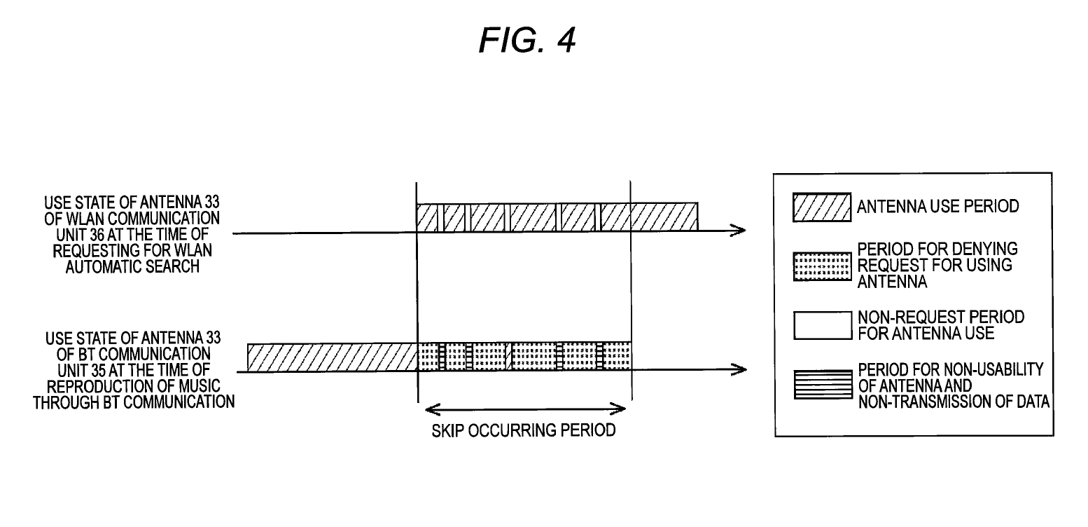

FIG. 4 is an exemplary diagram showing a use state of the wireless communication antenna 33 according to a related-art technology in a case where there is a request for starting WLAN communication in the middle of the BT communication.

A function of the cellular phone 10, which is capable of performing WLAN communication, for searching for the AP 12 is regarded as an important function. Because, originally WLAN communication cannot be performed in a state in which an AP 12 that is connectable is not known. Here, an example of a case where an automatic search process for an AP 12 through WLAN communication is prioritized with respect to a BT communication process in the cellular phone 10 will be described.

Accordingly, as shown in FIG. 4, when there is a request for starting the automatic search process for an AP 12 even in the middle of a period in which a user enjoys music data transmitted from the cellular phone 10 based on BT communication through the headset 11, the switching control section 46 controls the switching unit 34 such that the wireless communication antenna 33 is used to be prioritized with respect to the WLAN communication unit 36.

As a result, transmission of music data through BT communication may be delayed. The automatic search process for an AP 12 through WLAN communication is discretely performed. Accordingly, even in a time period from the start of the automatic search to the end thereof, it is apparent that time intervals during which the BT communication unit 35 can use the wireless communication antenna 33 also discretely exist. However, in a case where the headset 11 does not support the EDR, there are many cases where the discrete time interval during which the BT communication unit 35 can perform BT communication is shorter than the transmission time of data needed for smoothly reproducing the music. In particular, in a case where each of the discrete time intervals during which BT communication can be performed is shorter than a time needed for transmission of data corresponding to one packet in the BT communication not supporting the EDR, the BT communication cannot be performed. Accordingly, in a case where the headset 11 does not support the EDR, the user experiences a skipping of music that is listened to through the headset 11.

Thus, in order to prevent the skipping of music, the mobile terminal device according to the exemplary embodiment is configured not to receive a request for starting an automatic search process for an AP 12 through WLAN communication during a period in which a user enjoys music data, through the headset 11, transmitted from the cellular phone 10 through the BT communication not supporting the EDR and the like.

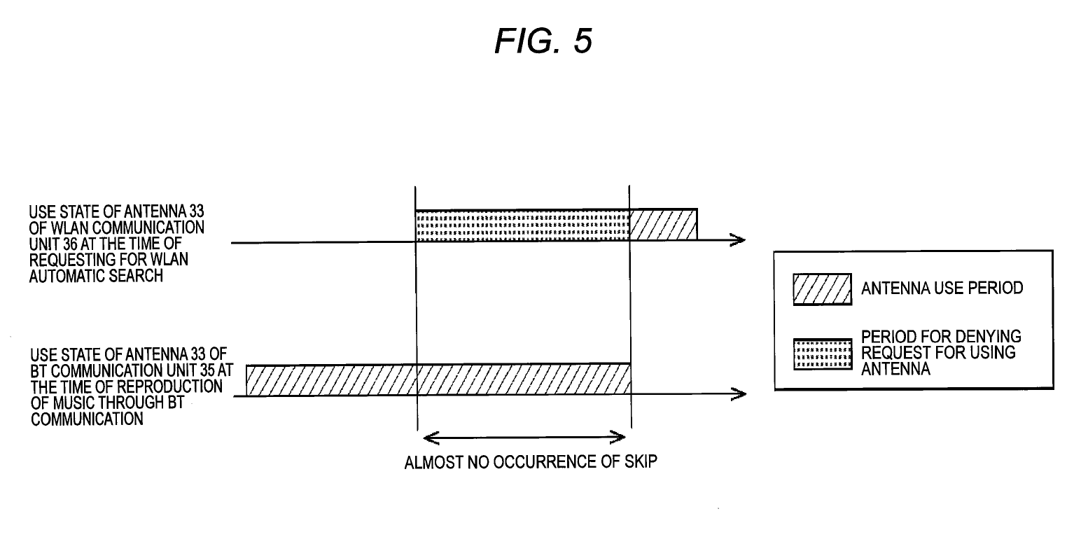

FIG. 5 is an exemplary diagram showing an example of a use state of the wireless communication antenna 33 of a mobile terminal device according to the exemplary embodiment in a case where there is a request for starting WLAN communication in the middle of the BT communication.

In a case where it is determined that there is a request for starting WLAN communication by the communication request determining section 43 at the time when BT communication is performed by the BT communication unit 35, when the BT communication is determined not to be performed according to the EDR by the speed determining section 44, and when the BT communication process is determined to be performed according to a given profile such as the A2DP by the communication content determining section 45, the communication control section 47 controls the BT communication unit 35, the WLAN communication unit 36, and the switching control section 46 so as to allow continuation of the BT communication by blocking the request for starting WLAN communication.

Accordingly, even in a case where a request for starting an automatic search for an AP 12 is generated through WLAN communication due to a movement of a user with the cellular phone 10 held or the like, the user can enjoy smoothly reproduced music almost without sensing any skipping thereof.

In addition, in the case where the BT communication performed by the BT communication unit 35 is continued by blocking the request for starting WLAN communication, the communication control section 47 or the WLAN communication unit 36 stores information indicating reception of the request for starting WLAN communication in a storage medium such as the RAM or the like of the main controller 37 or the WLAN communication unit 36. The communication control section 47 can use the information, for example, for performing (resuming) the WLAN communication when the reproduction of the music is completed.

For example, in a case where the BT communication process is determined not to be performed according to the given profile such as the A2DP (in a case where information indicating that the BT communication is performed according to the given profile is deleted from the required work area of the RAM of the main controller 37 by the BT communication control section 41), the communication control section 47 searches for the required work area of the RAM of the main controller 37. Then, in a case where the information indicating the reception of the request for starting WLAN communication is stored, the communication control section 47 controls the WLAN communication control section 42 to start WLAN communication. In order to perform WLAN communication in a speedy manner at a time when the reproduction of music is completed, the communication content determining section 45 may be configured to perform the determination consecutively or intermittently after the request for starting WLAN communication is denied by the communication control section 47 once.

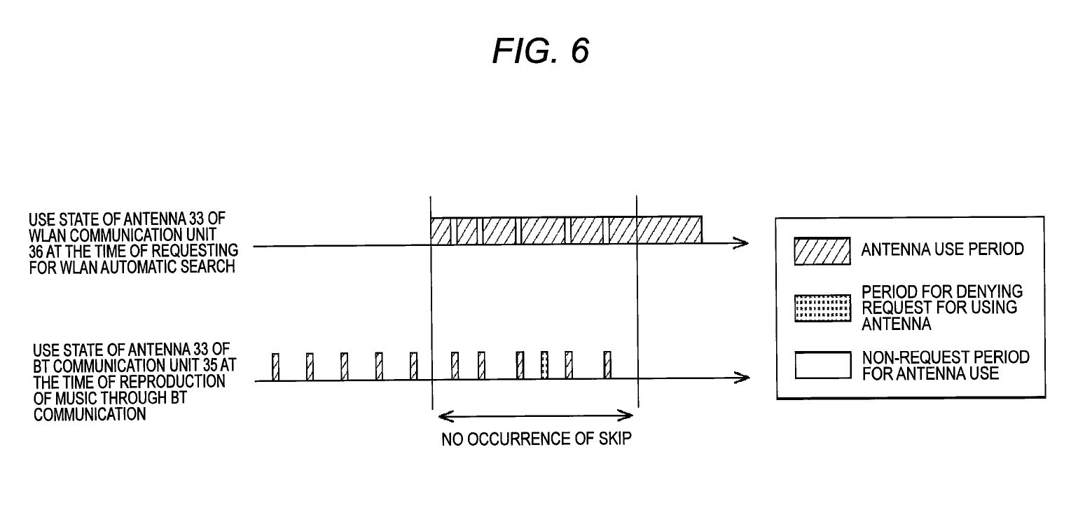

FIG. 6 is an exemplary diagram showing another example of the use state of the wireless communication antenna 33 of the mobile terminal device according to the exemplary embodiment in a case where there is a request for starting WLAN communication in the middle of the BT communication.

In the case illustrated in FIG. 5, even in a case where a request for starting an automatic search for an AP 12 is generated in a period during which transmission of music is performed through BT communication, the cellular phone 10 cannot automatically search for an AP 12 until the transmission of the music through BT communication is completed (until the information indicating that the BT communication is performed according to the predetermined profile is deleted from the required work area of the RAM of the main controller 37 by the BT communication control section 41). Accordingly, even when the automatic search for the AP 12 is immediately performed manually or automatically, a time is needed until the user can use WLAN communication after completion of the transmission of the music.

On the other hand, according to the BT communication using the EDR, even in the discrete time interval existing during the period of the automatic search process for an AP 12 through WLAN communication, data transmission needed for the smooth reproduction of music can be performed. Thus, in a case where BT communication is determined to be performed by using the EDR by the speed determining section 44, the communication control section 47 controls the BT communication unit 35, the WLAN communication unit 36, and the switching control section 46 to prioritize the WLAN communication with respect to BT communication. In addition, in a case where the BT communication process performed by the BT communication unit 35 is determined not to be performed according to the given profile such as the A2DP by the communication content determining section 45, similarly, the communication control section 47 prioritizes WLAN communication with respect to BT communication.

Here, “to prioritize WLAN communication with respect to BT communication” represents that the other end of the switching unit 34 is connected to the WLAN communication unit 36 regardless of the existence of a request for BT communication in a case where there is a request for WLAN communication from the WLAN communication control section 42, and the other end of the switching unit 34 is connected to the BT communication unit 35 only in a case where there is no request for WLAN communication and there is a request for BT communication from the BT communication control section 41.

In addition, when the request for WLAN communication and the request for BT communication are overlapped with each other, in the case of “prioritizing WLAN communication with respect to BT communication”, the request for BT communication is denied. Then, the communication control section 47 or the BT communication unit 35 may store information indicating reception of the request for BT communication in the storage medium such as the RAM of the main controller 37 or the BT communication unit 35. The communication control section 47 can use the information, for example, for performing (resuming) the BT communication when the request for WLAN communication ends or is temporarily stopped. In other words, the discrete time interval, during which the BT communication unit 35 can perform BT communication, arranged in the period of the process for automatic search for an AP 12 through WLAN communication can be assigned to BT communication more effectively.

As a result, in a case where BT communication is performed by using the EDR, even when a request for starting an automatic search for an AP 12 is generated through WLAN communication due to a movement of a user or the like, the user can enjoy smoothly reproduced music without sensing any skipping of the music. Accordingly, the cellular phone 10 can perform and complete the process of the automatic search for an AP 12 through WLAN communication in the middle of the reproduction of music.

Next, an example of the operation of the cellular phone 10 according to the exemplary embodiment will be described.

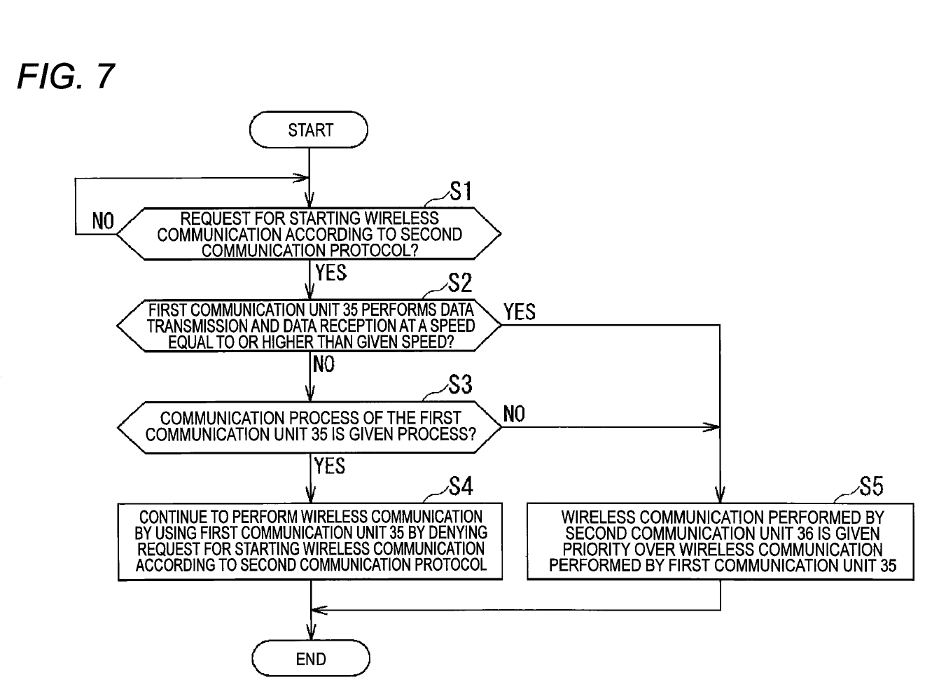

FIG. 7 is an exemplary flowchart showing a procedure for switching among a plurality of communication systems according to the content of the current wireless communication by the main controller 37 of the cellular phone 10 shown in FIG. 1. In FIG. 7, a reference sign denoted by adding a number to “S” represents each step in the flowchart.

The procedure is started at a time of starting BT communication by the BT communication unit 35 as the first communication module, and storing the profile information of the BT communication in the required work area of the RAM. In the description below, an example of a case where the cellular phone 10 delivers music data to the headset 11 through the BT communication unit 35 according to A2DP will be represented.

First, in Step S1, the communication request determining section determines whether there is a request for starting wireless communication according to the second communication system. More specifically, the communication request determining section 43 determines whether there is a request for starting an automatic search process for an AP 12 from the WLAN communication control section 42 through WLAN communication. In a case where there is the request for starting the automatic search process (Yes in Step S1), the process proceeds to Step S2. On the other hand, in a case where there is no request for starting the automatic search process (No in Step S1), a request for starting the automatic search process for an AP 12 through WLAN communication is continuously monitored.

Next, in Step S2, the speed determining section 44 determines whether the first communication unit 35 performs data transmission and data reception at a speed equal to or higher than a given speed. More specifically, the speed determining section 44 determines whether the BT communication is performed by using the EDR. In a case where the BT communication is not performed by using the EDR (No in Step S2), the process proceeds to Step S3. On the other hand, in a case where the BT communication is performed by using the EDR (Yes in Step S2) (see FIG. 6), the process proceeds to Step S5.

Next, in Step S3, the communication content determining section 45 determines whether the wireless communication process performed by the first communication unit 35 is a given process. More specifically, the communication content determining section 45 determines whether the BT communication process performed by the BT communication unit 35 is performed according to an A2DP, an HSP, an HFP, or any other audio/video data transmission profile by searching for the required work area of the RAM. In a case where the BT communication process is performed according to an audio/video data transmission profile such as the A2DP (Yes in Step S3) (see FIG. 5), the process proceeds to Step S4. On the other hand, when the BT communication process is not performed according to an audio/video data transmission profile (No in Step S3), the process proceeds to Step S5.

Next, in Step S4, the communication control section 47 allows the first communication unit 35 to continue the wireless communication by blocking the request for starting wireless communication according to the second communication system, and a series of the procedures is completed. More specifically, the control communication section 47 controls the BT communication unit 35, the WLAN communication unit 36, and the switching control section 46 to continue the BT communication by blocking the request for starting the automatic search process for an AP 12 through WLAN communication, and a series of the procedures is completed.

On the other hand, in Step S5, the communication control section controls the wireless communication performed by the first communication unit 35 and the wireless communication performed by the second communication unit 36 such that the wireless communication performed by the second communication unit 36 is performed to be prioritized with respect to the wireless communication performed by the first communication unit 35, and a series of the procedures is completed. More specifically, the communication control section 47 controls the BT communication unit 35, the WLAN communication unit 36, and the switching control section 46 so as to “prioritize the WLAN communication with respect to the BT communication”, and the series of the procedures is completed.

In a case where BT communication is performed according to an audio/video data transmission profile such as the A2DP and the BT communication is not performed by using the EDR, the cellular phone 10 according to the exemplary embodiment allows the continuation of the BT communication by blocking a request for starting WLAN communication even in a case where there is the request for starting WLAN communication at a time when the BT communication is performed. Accordingly, music data and video data can be transmitted to an external device through the BT communication without incurring any delay. Therefore, according to the cellular phone 10 of the exemplary embodiment, even when a request for starting an automatic search for an AP 12 is generated through the WLAN communication due to a movement of a user or the like, the user can listen to music delivered from the cellular phone 10 smoothly without sensing any skipping of the music.

In the case where the BT communication is performed by using the EDR, the cellular phone 10 according to the exemplary embodiment prioritizes the WLAN communication with respect to the BT communication. Accordingly, in a case where a request for starting an automatic search for an AP 12 is generated through the WLAN communication, the user can listen to music smoothly delivered from the cellular phone 10 without sensing any skipping of the music. Therefore, the cellular phone 10 can perform and complete the automatic search process for an AP 12 through the WLAN communication in the middle of the reproduction of music performed through the BT communication.

The present invention is not limited to the above-described exemplary embodiment, and may be embodied by changing the constituent elements within the scope not departing from the basic idea thereof in a practical implementation stage. In addition, various inventions can be formed by appropriately combining a plurality of the constituent elements disclosed in the exemplary embodiment. For example, several constituent elements may be eliminated from all the constituent elements represented in the exemplary embodiment.

For example, the present invention can be applied to various mobile terminal devices other than the cellular phone 10 described in the exemplary embodiment, and more particularly, to mobile information processing devices such as a notebook personal computer, a Personal Digital Assistant (PDA), a mobile game device, a mobile music player, and a mobile video player.

In addition, in the exemplary embodiment, an example of a case where one wireless communication antenna 33 is commonly used by the BT communication unit 35 and the WLAN communication unit 36 through the switching unit 34 is represented. However, each of the BT communication unit 35 and the WLAN communication unit 36 may have a dedicated antenna. Even in the case where each of the BT communication unit 35 and the WLAN communication unit 36 has a dedicated antenna, when one of the BT communication and the WLAN communication is selectively performed by using the technique used to control the switching unit 34, the problem of frequency interference can be prevented in advance, and the same advantages as those of the exemplary embodiment can be acquired.

In addition, in a case where the BT communication and the WLAN communication are simultaneously performed, in order to prevent the problem of frequency interference in advance, it should be noted that the BT communication control section 41 must perform the BT communication by avoiding a channel used by the WLAN communication by adaptive frequency hopping or the like.

In addition, a request (for example, a manual request for starting a search for an AP 12 or the like), which is directed by a user through the input unit 24, amongst requests for starting WLAN communication may be configured to be accepted by stopping the BT communication on the basis of the A2DP or the like. In such a case, even when skipping occurs in the reproduction of music through the BT communication, it is not unexpected by the user, and there is no concern about misleading the user to consider a breakdown of the device or the like. In such a case, in order to clarify a stopped state of the BT communication that is caused by the user, an image indicating the stopped state may be displayed on the display portion 26.

In the exemplary embodiment of the present invention, the steps shown in the flowchart represent an example of processes performed in a time series according to the described order. However, the steps may be performed in parallel with each other or may be individually performed, without necessarily being processed in a time series.

The present invention is not limited to the foregoing embodiments but various modifications of its component may be made without departing from the scope of the present invention. Also, the components disclosed in the embodiments may be assembled in any combination for embodying the present invention. For example, some of the components may be omitted from all the components disclosed in the embodiments. Further, components in different embodiments may be appropriately combined.

What is claimed is:

1. A mobile terminal device comprising:
a first communication module which performs first wireless communication according to a first communication system;
a second communication module which performs second wireless communication according to a second communication system; and
a main controller which controls the first communication module and the second communication module,
wherein the main controller controls the first communication module to continue the first wireless communication by rejecting a request for starting the second wireless communication while given communication processing is performed by the first communication module, and
wherein the main controller controls the first communication module to terminate the first wireless communication and controls the second communication module to perform the second wireless communication in response to the request, when the given communication processing is not performed.

2. The device of claim 1,
wherein the main controller comprises:
a speed determining section which determines whether the first wireless communication is performed at a speed equal to or higher than a given speed;
a communication content determining section which determines whether the given communication processing is performed by the first communication module; and
a communication control section which determines that the first communication module continues the first wireless communication by rejecting the request while the speed determining section determines that the first wireless communication is performed at a speed lower than the given speed, and
wherein the communication control section determines that the second wireless communication is performed in response to the request, when the speed determining section determines that the first wireless communication is performed at a speed equal to or higher than the given speed.

3. The device of claim 1 further comprising:
a wireless communication antenna which is selectively used by one of the first communication module and the second communication module;
a switching module which implements one of a connection between the wireless communication antenna and the first communication module and a connection between the wireless communication antenna and the second communication module by having one end connected to the wireless communication antenna and the other end connected to one of the first communication module and the second communication module; and
a switching controller which connects the other end of the wireless communication antenna to one of the first communication module and the second communication module by controlling the switching module,
wherein the main controller controls a connection destination of the wireless communication antenna by controlling the switching module through the switching control section.

4. The device of claim 2 further comprising:
a wireless communication antenna which is selectively used by one of the first communication module and the second communication module;
a switching module which implements one of a connection between the wireless communication antenna and the first communication module and a connection between the wireless communication antenna and the second communication module by having one end connected to the wireless communication antenna and the other end connected to one of the first communication module and the second communication module; and
a switching controller which connects the other end of the wireless communication antenna to one of the first communication module and the second communication module by controlling the switching module,
wherein the communication control section controls a connection destination of the wireless communication antenna by controlling the switching module through the switching control section.

5. A mobile terminal device comprising:
a first communication module which performs first wireless communication according to a first communication system;
a second communication module which performs second wireless communication according to a second communication system; and
a main controller which controls the first communication module and the second communication module,
wherein the main controller controls the first communication module to terminate the first wireless communication and controls the second communication module to perform the second wireless communication in response to a request for starting the second wireless communication, when the first wireless communication is performed at a speed equal to or higher than a given speed.

6. The device of claim 5,
wherein the main controller comprises:
a speed determining section which determines whether the first wireless communication is performed at a speed equal to or higher than a given speed;
a communication content determining section which determines whether the given communication processing is performed by the first communication module; and
a communication control section which determines that the first communication module continues the first wireless communication by rejecting the request while the speed determining section determines that the first wireless communication is performed at a speed lower than the given speed, and
wherein the communication control section determines that the second wireless communication is performed in response to the request, when the speed determining section determines that the first wireless communication is performed at a speed equal to or higher than the given speed.

7. The device of claim 5 further comprising:
a wireless communication antenna which is selectively used by one of the first communication module and the second communication module;
a switching module which implements one of a connection between the wireless communication antenna and the first communication module and a connection between the wireless communication antenna and the second communication module by having one end connected to the wireless communication antenna and the other end connected to one of the first communication module and the second communication module; and
a switching controller which connects the other end of the wireless communication antenna to one of the first communication module and the second communication module by controlling the switching module,
wherein the main controller controls a connection destination of the wireless communication antenna by controlling the switching module through the switching control section.

8. The device of claim 6 further comprising:
a wireless communication antenna which is selectively used by one of the first communication module and the second communication module;
a switching module which implements one of a connection between the wireless communication antenna and the first communication module and a connection between the wireless communication antenna and the second communication module by having one end connected to the wireless communication antenna and the other end connected to one of the first communication module and the second communication module; and
a switching controller which connects the other end of the wireless communication antenna to one of the first communication module and the second communication module by controlling the switching module,
wherein the communication control section controls a connection destination of the wireless communication antenna by controlling the switching module through the switching control section.

9. A communication control method of a mobile terminal device including a first communication module which performs first wireless communication according to a first communication system, a second communication module which performs second wireless communication according to a second communication system, and a main controller which controls the first communication module and the second communication module, the communication control method comprising:
receiving a request for starting the second wireless communication when the first wireless communication is performed; and
performing at least one of the following two steps of:
(a) continuing to perform the first wireless communication by rejecting the request while given communication processing is performed by the first communication module, and terminating the first wireless communication and performing the second wireless communication in response to the request when the given communication processing is not performed; and
(b) performing the second wireless communication in response to the request, when the first wireless communication is performed at a speed equal to or higher than a given speed.

10. The method of claim 9 further comprising:
determining whether the first wireless communication is performed at a speed equal to or higher than a given speed;
determining whether the given communication processing is performed by the first communication module;
receiving the request for starting the second wireless communication when the first wireless communication is performed;
continuing to perform the first wireless communication by rejecting the request while the first wireless communication is performed at a speed lower than the given speed; and
terminating the first wireless communication and performing the second wireless communication in response to the request, when the first wireless communication is performed at a speed equal to or higher than the given speed.
